(19) United States
(12) Patent Application Publication
(10) Pub. No.: US 2013/0052624 A1
(43) Pub. Date: Feb. 28, 2013

(54) TRIDIMENSIONAL STOOL ASSESSMENT INSTRUMENT, METHODS, AND USES THEREOF

(71) Applicants: Miguel Saps, Highland Park, IL (US); Ashish Chogle, Oak Brook, IL (US)

(72) Inventors: Miguel Saps, Highland Park, IL (US); Ashish Chogle, Oak Brook, IL (US)

(21) Appl. No.: 13/592,906

(22) Filed: Aug. 23, 2012

Related U.S. Application Data
(60) Provisional application No. 61/527,459, filed on Aug. 25, 2011.

(51) Int. Cl. G09B 23/28

(52) U.S. Cl. 434/262

(57) ABSTRACT

The present invention relates to a tridimensional stool assessment instrument for evaluating stool type of a subject including a mock toilet and tridimensional models of exemplary stool types sized for placement in the mock toilet. The present invention also relates to methods of evaluating or diagnosing a subject having, or having a propensity to develop, a gastrointestinal disease using the tridimensional stool assessment instrument of the present invention. Moreover, the present invention relates to a kit.

### RELATED APPLICATIONS

This application claims the benefit of U.S. Provisional Patent Application No. 61/527,459 filed Aug. 25, 2011; which is hereby incorporated by reference.

### BACKGROUND

1. Technical Field

The present invention relates to a stool assessment instrument or chart, methods and uses thereof. Specifically, the present invention relates to tridimensional stool assessment instrument and chart, and methods.

2. Background Information

Constipation and irritable bowel syndrome (IBS) are among the most common gastrointestinal disorders in adults and children. Diagnosis of constipation and irritable bowel syndrome is clinical and based on patient's report of symptoms and stool consistency. Patient's report of stool characteristics is used in the assessment of treatment efficacy, to establish changes in medication and to evaluate clinical progress (Chumpitazi B, et al., Journal Pediatrics, 157:594-597 (2010)).

In 1997, Lewis et al. developed the Bristol Stool Scale Form (BSFS; FIG. 1) as a method of assessing intestinal transit time in adults (Lewis S J, et al., Scand J Gastrotrnterol, 32:920-924 (1997)). The BSFS is a paper chart scale composed of 2-dimensional representations of the various stool types ordered in a vertical fashion with each stool type depicted in association with a text description of each stool type. The BSFS is widely used in patients with functional gastrointestinal disorders (FGIDs) in clinical care. Adults and children with IBS and constipation are often asked to maintain a stool diary to evaluate their stool consistency and to make necessary changes in their treatment. The BSFS has also been endorsed by the FDA and the Rome criteria.

The last edition of the Rome criteria recommends using the BSFS to evaluate stool form in adult patients with functional bowel disorders (Longstreth G F, et al., Gastroenterology, 130(5):1480-91 (April 2006)). Recently issued FDA draft guidelines recommended using the BSFS to assess primary end points in drug clinical trials.

Despite its widespread use no studies have validated the BSFS in adults or children for these purposes. Also, developmental limitations often hinder child's utilization of scales specifically designed to be used in adults.

Specifically, evolving developmental stages make children's population unique. According to Piaget, children progress through cognitive stages with distinct developmental differences between children 7-11 years of age (concrete operational state) and children older than 12 years of age (formal operational state) (Kiese-Himmel C, Liebeck H., Prax Kinderpsychol Kinderpsychiatr., 47(4):217-28 (1998)). Children at the concrete operational level are at the initial states of logical reasoning and coherent thought organization and can only think about actual physical objects while are unable to handle abstract reasoning. Children at the formal operational stage are able to think abstractly and better understand form or structure of problems.

This has led researchers to develop a modified version of BSFS. The modified version (M-BSFS; FIG. 2) uses what was proposed as “child friendly” descriptors for each of seven pictorial stool depictions included in the BSFS. The psychometric characteristics of the BSFS or its modified version, however, have not yet been studied in children. It is unclear whether children are able to conceptualize the pictures of BSFS and whether the modified wording included in the M-BSFS is easier to understand by children, and whether other means of assessment could be helpful in children's stool assessment.

In fact, the use of the currently used instruments (BSFS and M-BSFS) is still challenging and the available instruments perform poorly with children. Uncertainty about the validity of available instruments is not limited to the pediatric population. Studies have shown that adult patients are often confused when using the BSFS (Spiegel B M, et al. Do Patients Understand the Bristol Stool Scale? Results of Cognitive De-Briefing of IBS Patients. Digestive Disease Week. May 7^{th}-10^{th}, 2011. Chicago, Ill.).

As such, there still is a need for improved, validated stool instruments and/or scales to assess stool characteristics in adults and children to help with quicker and more accurate diagnosis and treatment of gastrointestinal disorders.

### SUMMARY

The present invention relates a tridimensional stool assessment instrument for evaluating stool type of a subject including a toilet and at least one tridimensional model of an exemplary stool type sized for placement in the toilet. The toilet may be a mock toilet. The subject may be an adult or a pediatric subject. The mock toilet may resemble in size a working toilet or may be reduced in size as compared to a working toilet. In one embodiment, the mock toilet may be approximately 25 cm in height. The mock toilet may be made from a resin material. The subject has, or is at risk of acquiring, a gastrointestinal disease. The gastrointestinal disease may be selected from the group consisting of gastrointestinal motility disorder, chronic intestinal pseudo-obstruction, colonic pseudo-obstruction, duodenogastric reflux, dyspepsia, functional dyspepsia, nonulcer dyspepsia, functional gastrointestinal disorder, functional heartburn, gastroesophageal reflux disease, gastroparesis, irritable bowel syndrome, post-operative ileus, and constipation. The tridimensional stool assessment instrument may include at least five tridimensional models of exemplary stool types. The tridimensional stool assessment instrument may include at least seven tridimensional models of exemplary stool types. The tridimensional stool assessment instrument may include a plurality of tridimensional models of exemplary stool types. The tridimensional stool assessment instrument may include at least seven tridimensional models of the exemplary stool types, the stool types corresponding to the seven types of stools depicted by the Bristol Stool Scale Form. The tridimensional model of stool may be made from a resin material. The tridimensional stool model may have an appearance of floating or sinking in the mock toilet depending on the stool type. The tridimensional stool assessment instrument may further include a tridimensional model of blood, a tridimensional model of mucus, and a tridimensional model of pus.

In another embodiment, the present invention relates to a method of evaluating a subject having, or having a propensity to develop, a gastrointestinal disease. The method includes providing a tridimensional stool assessment instrument to the patient, the instrument comprising a toilet and a plurality of tridimensional models of an exemplary stool types sized for placement in the toilet. The method further includes placing individual tridimensional models of the exemplary stool types in the toilet and instructing the subject to identify the tridimensional stool model that best resembles the stool type of the subject. In the method the gastrointestinal disorder may be gastrointestinal motility disorder, chronic intestinal pseudo-obstruction, colonic pseudo-obstruction, duodenogastric reflux, dyspepsia, functional dyspepsia, nonulcer dyspepsia, functional gastrointestinal disorder, functional heartburn, gastroesophageal reflux disease, gastroparesis, irritable bowel syndrome, post-operative ileus, or constipation. In the method, the subject may be a pediatric subject.

In a further embodiment, the present invention relates to a method of diagnosing a subject as having, or having a propensity to develop, an inflammatory bowel disease or constipation, the method includes providing a tridimensional stool assessment instrument to the subject, the instrument comprising a toilet and a plurality of the tridimensional models of an exemplary stool types sized for placement in the toilet. The method also includes placing individual tridimensional models of the exemplary stool types in the toilet and instructing the subject to identify the tridimensional stool model that best resembles the stool type of the subject.

In yet another embodiment, the present invention relates to a kit that includes a mock toilet; at least one tridimensional model of an exemplary stool type sized for placement in the mock toilet; and optionally, a tridimensional model of blood; a tridimensional model of mucus; and a tridimensional model of pus. In the method, the tridimensional models of blood, mucus and pus are sized for placement in the mock toilet on top of the at least one tridimensional model of an exemplary stool type.

### BRIEF DESCRIPTION OF THE DRAWINGS

FIG. 1 depicts the prior art Bristol Stool Form Scale (BSFS);

FIG. 2 depicts prior art Modified Bristol Stool Form Scale (M-BSFC);

FIG. 3A depicts one embodiment of the present invention;

FIG. 3B depicts the tridimensional stool models of the present invention;

FIG. 3C depicts an exemplary stool type;

FIG. 4 depicts exemplary measurements of the tridimensional models of the present invention;

FIGS. 5A-C depict exemplary tridimensional models of the present invention; and

FIG. 6A depicts an exemplary embodiment of the present invention;

FIG. 6B depicts one embodiment of the present invention;

FIG. 7 depicts exemplary stool types; and

FIG. 8 depicts an example of “currant jelly” stools seen in patients with intussusception.

### DETAILED DESCRIPTION OF THE DRAWINGS AND THE PRESENTLY PREFERRED EMBODIMENTS

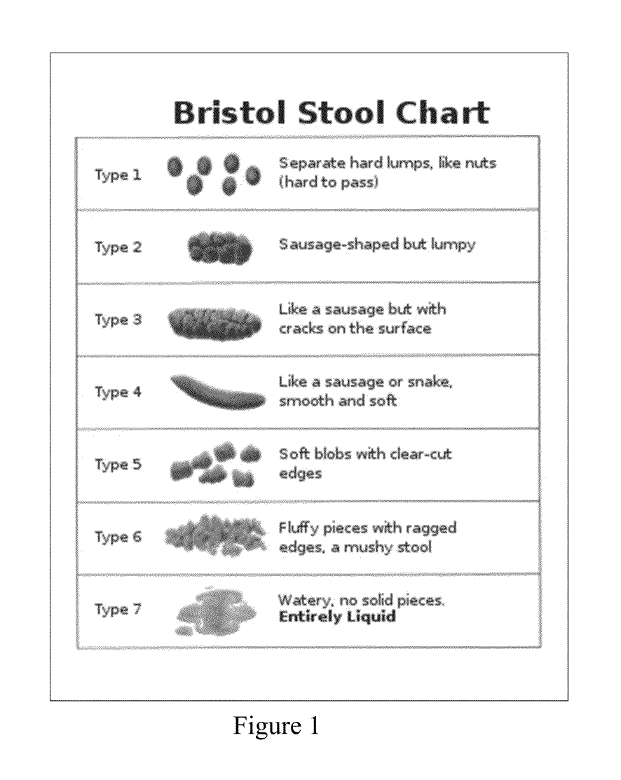

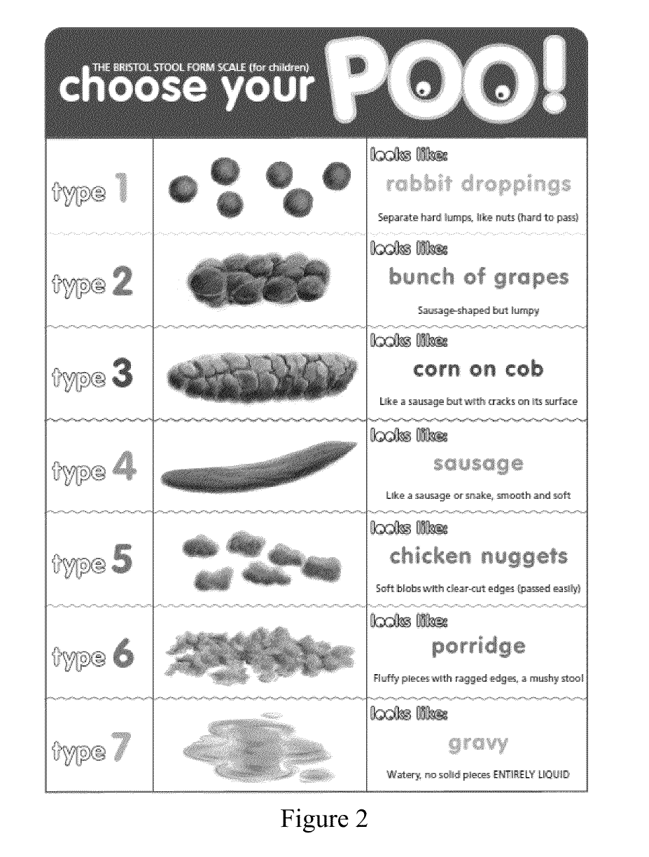

It has been previously found that the BSFS (FIG. 1) and the proposed modification of the instrument, the M-BSFS (FIG. 2) were not reliable tools for assessing stool characteristics in children. Specifically, only 33% of children were able to correlate correctly the stools pictures of the BSFS with the instrument wording. There was no significant difference between the ability of the children to correlate correctly the stool depiction using the BSFS wording and the “supposedly” children friendly wording of the modified version (M-BSFS).

As mentioned previously, evolving developmental stages make children's population unique. Children at the concrete operational level are at the initial states of logical reasoning and coherent thought organization and can only think about actual physical objects while are unable to handle abstract reasoning. Children at the formal operational stage are able to think abstractly and better understand form or structure of problems.

Because the current instrument for assessment of stool in children are unfriendly to children and perform poorly, the present inventors looked to invent a children-friendly instrument that could be used to assess stool characteristics in children to help with quicker and more accurate diagnosis and treatment of gastrointestinal disorders in children as well as adults.

In one embodiment, the present invention relates to a stool assessment instrument or scale for assessing and/or evaluating stool characteristics in patients including adult and pediatric patients. Specifically, the present invention relates to a tridimensional stool instrument for assessing and/or evaluating stool characteristics in patients, such as pediatric patients.

The terms “assess,” “assessment,” “assessing”, “evaluate,” “evaluation,” or “evaluating” refer to an examiner's (e.g., physician, doctor, medical personnel, etc.) evaluation of the disease or condition based on the patient's subjective report of the symptoms, characteristics and course of the illness or condition and the examiner's objective findings, including information reported by family members and other health care team members.

The terms “subject” or “patient” means a recipient of a health care service or assessment or evaluation. The subject may be a human patient or an animal patient. The subject may be a pediatric or an adult, including geriatric or patient.

The term “pediatric” subject means a child in the age range from 0 to 21 years old.

The term “adult” patient refers to a patient in the age range from 21 to 64 years.

The term “geriatric” patient refers to an adult patient in the age range 65 years and above.

In one embodiment, the tridimensional stool instrument for evaluating or assessing stool type of a subject includes a toilet and at least one removable tridimensional model of an exemplary stool type that is sized for placement in the toilet. In certain embodiments the toilet may be a mock toilet constructed to simulate a working toilet. In certain embodiments, the subject may be a pediatric or an adult subject.

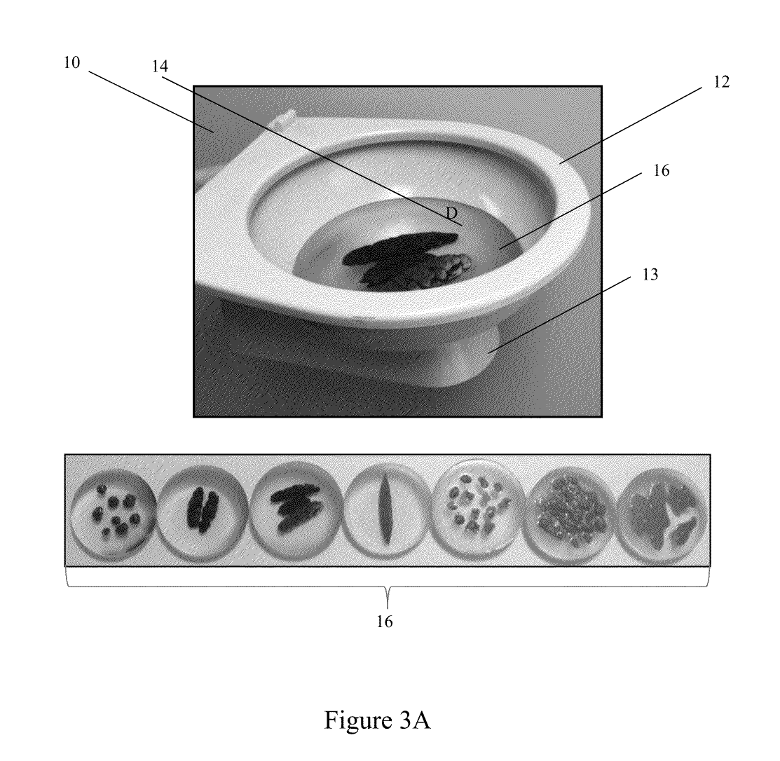

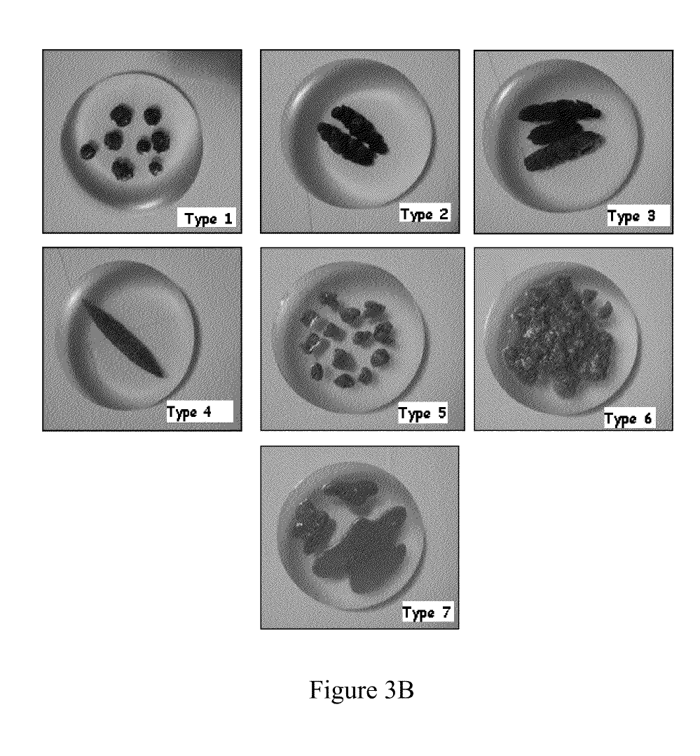

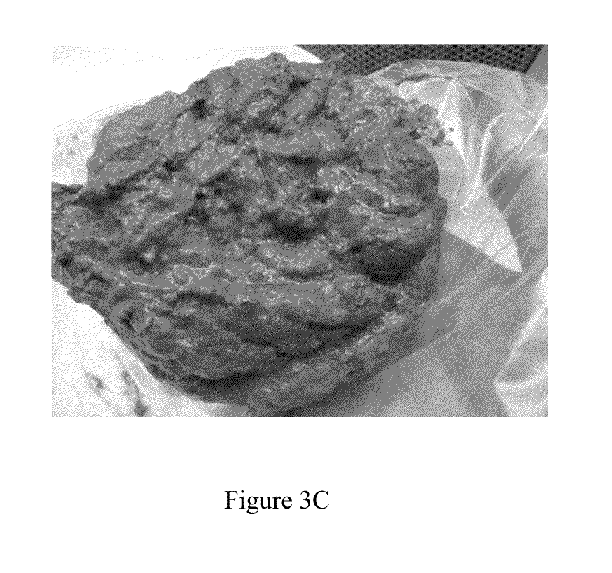

Referring now to FIG. 3A, there is shown a mock toilet 10 constructed to simulate a working toilet. The toilet 10 comprises a toilet bowl 12 which may be constructed of a molded plastic material well known in the art and having an inner diameter 14 and which is supported on a molded base 13 which may be constructed of the same molded material. Preferably, the toilet elements are constructed as a single piece from a single piece of material. Preferably, the bowl 12 of the mock toilet is shaped in the manner of a normal, working toilet bowl. Integral to the upper surface of the bowl 12 is a toilet seat that resembles a working toilet seat. The seat may, optionally, be covered by a toilet seat cover which may be rotatably attached at a pair of hinges to the mock toilet 10.

In certain embodiments, to better simulate a working toilet, attached to the bowl 12 may be a reservoir (not shown).

Any or all portions of the mock toilet may be constructed of moldable plastic material. In one embodiment, the mock toilet is approximately 25 cm in height but may be of different size. In certain embodiments, the mock toilet may be of the size of the actual working toilet and be of varying shapes consistent with the varying shapes of any working toilet. The mock toilet may of any size and color. Preferably the mock toilet is white.

In an assessment situation, a desired tridimensional model of an exemplary stool (16) is placed in the bowl 12 of the mock toilet 10.

Referring to FIGS. 3A-B, the tridimensional stool instrument or scale of the present invention also includes at least one tridimensional model of an exemplary stool type 16. In certain embodiments, the tridimensional stool instrument of the present invention includes at least three, more preferably at least five, and most preferably at least seven tridimensional models of the exemplary stool types. In certain embodiments, the tridimensional stool assessment instrument of the present invention includes a plurality of tridimensional models of the exemplary stool types (e.g., 1, 2, 3, 4, 5, 6, 7, 8, 9, 10, 11, 12, 13, 14, 15, 16, 17, 18, 19, 20, or more). In one embodiment, the exemplary tridimensional models of the stool type are similar or correspond to the two-dimensional drawings depicted by the BSFS. In alternative embodiment, the exemplary tridimensional models of the stool type include additional types of stools not depicted in the current charts, such as BSFS. For example, the exemplary tridimensional model of the stool type may include a model of the stool with blood, as shown in FIG. 3C.

The tridimensional model 16 consists of the exemplary stool type typically embedded in a clear resin material. The tridimensional model is sized for placement inside the toilet bowl or a mock toilet bowl 12. Preferably the tridimensional model is sized for placement inside of the mock toilet about half way down the toilet bowl as shown in FIG. 3A.

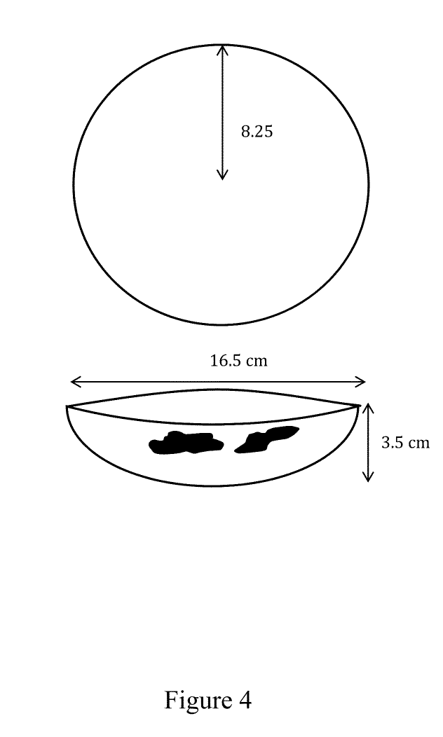

The tridimensional model is sized from about 1 cm to about 100 cm in diameter and from about 1 cm to about 50 cm in height. More preferably, the model is sized from about 5 cm to about 20 cm in diameter and from about 2 cm to about 10 cm in height. In one embodiment, the tridimensional models are 16.5 cm in diameter and 3.5 cm in height resin 3-D models depicting each BSFS stool type (as illustrated in FIG. 4).

The exemplary stool type may be identical, similar to or different from the stool types provided in The Bristol Stool Form Scale (BSFS), illustrated in FIG. 1, which is validated stool scale designed to assess colonic transit time in adult patients (Lewis S J, Heaton K W., Scand J Gastroenterol, 32: 920-924 (1997). BSFS classifies stool forms into 7 categories ranging from hard stools (type 1 and 2) to loose stools (types 5, 6 and 7) with an intermediate category considered normal stool (type 4) with a text description as follows:

Type 1—“Separate hard lumps, like nuts (hard to pass)”

Type 2—“Sausage-shaped but lumpy”

Type 3—“Like a sausage but with cracks on the surface”

Type 4—“Like a sausage or snake, smooth on a surface”

Type 5—“Soft blobs with clear-cut edges”

Type 6—“Fluffy pieces with ragged edges, a musty stool”

Type 7—“Watery no solid pieces. Entirely Liquid”

The exemplary tridimensional model of the stool type can be made from a moldable plastic or resin material or the like in color to best resemble actual stools. The exemplary tridimensional model of the stool type may be to scale to simulate human stool form (for use with an actual working toilet or for use with a mock toilet that is sized similarly to the actual working toilet) or may be reduced in size to accommodate a smaller version of the mock toilet.

The tridimensional stool models are colored to correspond to colors of the actual stools of a subject. Depending on the type of the stool, the tridimensional stool models can be of any shade of yellow, orange, brown, green, black, red, or a combination thereof.

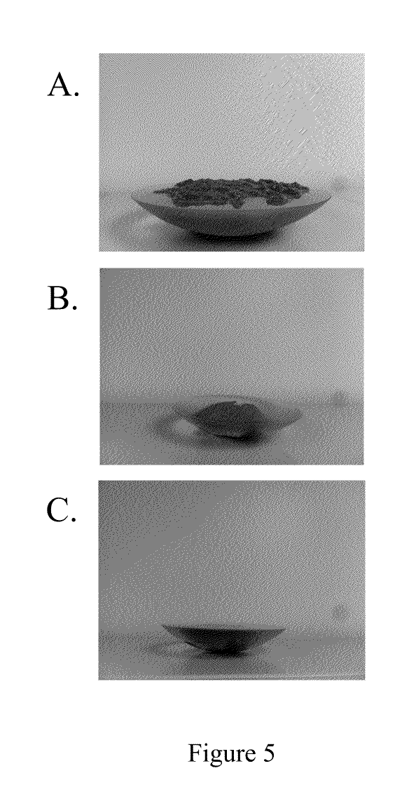

In one embodiment, the tridimensional stool models of the present invention provide an impression that they are capable of “floating” or “sinking” in the mock toilet depending on the stool type to simulate human stool upon defecation in a working toilet. This could be accomplished by embedding the exemplary stool type at different depths or heights of the clear resin used to make the tridimensional models of the present invention as shown in FIGS. 5A-C. For example, a loose, liquid stool type would be closer or just above the surface of the surrounding clear resin to appear as though it was “floating” on top of the surface of the water in the toilet bowl (FIG. 5A); the hard stools would be embedded at a greater depth of the resin (away from the surface of the resin towards the bottom of the model) so that they appear as though the stools are “sinking” into the toilet bowl (FIG. 5B-C).

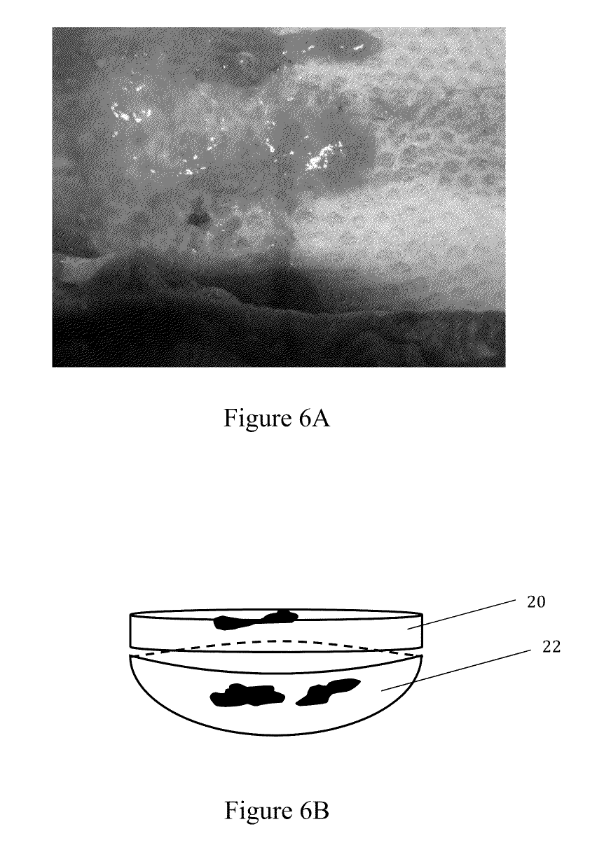

In certain embodiments, the stool assessment instrument of the present invention may further include additional tridimensional models that are clear and/or resemble blood, mucus (FIG. 6A) and/or pus (not shown). The blood, mucus and/or pus can be made from a moldable plastic or resin material or the like in color that resembles blood, mucus and/or pus and embedded in clear resin material. As shown in FIG. 6B, these tridimensional clear models or models of blood, mucus and/or pus 20 can be designed to be placed over the tridimensional models of the exemplary stool types 22.

The tridimensional stool instrument of the present invention may be used for assessment of a patient, such as a pediatric patient at risk of acquiring or already suffering from an acute or chronic gastrointestinal disease or disorder such as, for example, gastrointestinal motility disorder, chronic intestinal pseudo-obstruction, colonic pseudo-obstruction, duodenogastric reflux, dyspepsia, functional dyspepsia, nonulcer dyspepsia, functional gastrointestinal disorder, functional heartburn, gastroesophageal reflux disease, gastroparesis, irritable bowel syndrome, post-operative ileus, constipation, and other gastro-intestinal disorder. For example, if a patient identifies the stool type as Type 1 or Type 2, this may be indicative of constipation. In another example, if a patient identifies the stool types as Type 7, this may be indicative of diarrhea.

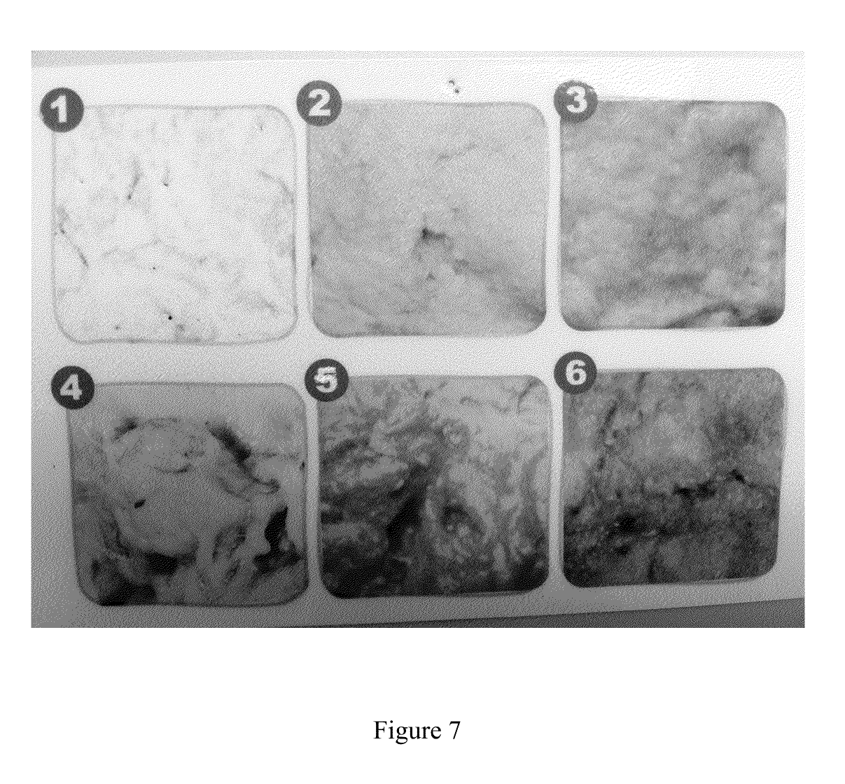

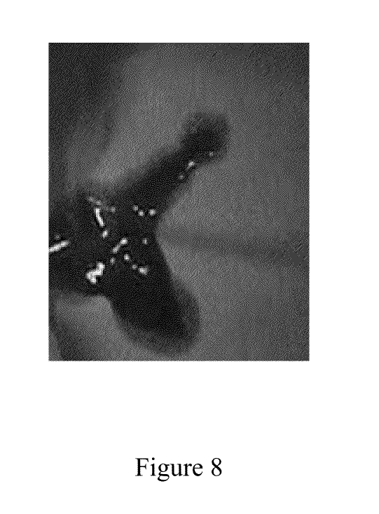

In certain embodiments, the tridimensional stool instrument of the present invention may be used for assessment of a patient, such as a pediatric patient at risk of acquiring or already suffering from an acute or chronic disease or disorder other than a gastrointestinal disease or disorder, such as flu, biliary atresia (FIG. 7), cystic fibrosis, and/or intussusception (FIG. 8). In certain other embodiments, the tridimensional stool instrument of the present invention may be used to screen for blood in stool of elderly for early diagnosis of conditions such as polyps or cancer.

In certain embodiments, the tridimensional stool instrument of the present invention may be used for educational purposes, for example, at medical schools, doctor offices, hospitals, geriatric centers or homes, etc.

For example, the tridimensional stool instrument of the present invention may be used for education of mothers/pregnant women about normal stool appearance in infants/toddlers and kids of preschool age. In certain embodiments, the tridimensional stool instrument of the present invention may be used to educate mothers about toddler diarrhea. In alternative embodiments, the tridimensional stool instrument of the present invention may be used for epidemiological purposes to learn about the stool patterns in communities or countries.

In certain embodiments, the invention relates to a method of evaluating a subject, such as a pediatric subject. The subject may be in need of a treatment. The method includes providing a tridimensional stool assessment instrument to the subject, wherein the instrument includes a toilet and a plurality of tridimensional models of the exemplary stool types sized for placement in the toilet. The method further includes placing individual tridimensional models of the exemplary stool types in the toilet and instructing the subject to identify the tridimensional stool model that best resembles the stool type of the subject.

In yet another embodiment, the invention relates to a method of diagnosing a gastrointestinal disease in a subject having, or having a propensity to develop, the gastrointestinal disease. The method includes providing a tridimensional stool assessment instrument to the subject, wherein the instrument includes a toilet and a plurality of tridimensional models of the exemplary stool type sized for placement in the toilet, placing individual tridimensional models of the exemplary stool types in the toilet, and instructing the subject to identify to the tridimensional stool model that best resembles the stool type of the subject.

Further steps, such as evaluating the actual stool sample and other diagnostic procedures, can be taken to confirm the diagnosis based on the initial screening using the stool assessment instrument of the present invention.

Expectations of children being able to classify stool type in 7 different categories may be unrealistic in children. Unusual expectations not based on children's developmental abilities may be a consequence of using adult based instruments in children.

Based on the results from the experiments described in Examples 1-6 below, the 3-D stool assessment instrument of the present invention is superior as compared to the BSFS and M-BSFS.

3-D stool assessment instrument constitutes a friendlier instrument that can be used at various ages without developmental distinction.

When compared with the BSFS, the use of the newly designed 3-D instrument surprisingly resulted in a larger percentage of correct stool type characterization in children. The overall correct response for stool consistency was higher for hard, loose and normal stools using the 3-D stool assessment instrument of the present invention than the BSFS with a significant difference in correct characterization in hard stool consistency. It is believed that the sample size limitations may have resulted in the absence of significant differences in the loose stool type.

The poor performance of the currently used instruments (BSFS and M-BSFS) is challenging. There is a clear need for validated instruments to be used in children. Uncertainty about the validity of available instruments is not limited to the pediatric population. Studies have shown that adult patients are often confused when using the BSFS (Spiegel B M, et al. Do Patients Understand the Bristol Stool Scale? Results of Cognitive De-Briefing of IBS Patients. Digestive Disease Week. May 7^{th}-10^{th}, 2011. Chicago, Ill.).

The results of the present study surprisingly suggest that the 3-D stool assessment instrument of the present invention could also be used for accurate diagnosis. 3-D instrument of the present invention may also help improve accuracy of characterization of stool types in younger children. It is possible that a 5 stool type version of our 3-D instrument may result in a more accurate characterization of stool types. It was found >70% of correct agreement between the 3-D stool models and the BSFS wording for all stool types except type 5.

As such, the strengths and advantages of this invention include that cognizant of children's developmental stages, the 3-D models of this invention can be used as diagnostic tools in pediatric gastroenterology.

### EXAMPLES

Due to the lack of information on whether children would benefit from a tridimensional (3-D) version of each stool type. The usability of the two current stool scale instruments, BSFS and Modified BSFS (M-BSFS) was compared with the newly designed tridimensional stool instrument of the present invention.

Materials

The BSFS (FIG. 1) is a validated stool scale designed to assess colonic transit time in adult patients (Lewis S J, Heaton K W., Scand J Gastroenterol 32: 920-924 (1997)). The BSFS classifies stool forms into 7 categories ranging from hard stools (type 1 and 2) to loose stools (types 5, 6 and 7) with an intermediate category considered normal stool (type 4). The BSFS is a paper chart scale composed of 2-dimensional representations of the various stool types ordered in a vertical fashion with each stool type depicted in association with a text description.

The M-BSFS (FIG. 2) is an internet available instrument (http://www.childhoodconstipation.com/gfx/bristol_stool.jpg) that is currently used by some practitioners and pharmaceutical companies to characterize stools in children. No validation for this instrument is available. The M-BSFS uses the same pictures of the BSFS with different descriptors. Specifically, the M-BSFS describes type 1 as “rabbit droppings”, type 2 as “bunch of grapes”, type 3 as “corn on cob”, type 4 as “sausage”, type 5 as “chicken nuggets”, type 6 as “porridge” and type 7 as “gravy”.

3-D Model Instrument (FIG. 3A-B) is a version of the BSFS that was especially constructed by an artist who was provided with the BSFS. The custom made 3-D instruments were constructed in resin and included a 25 cm height white mock toilet (10) and seven 6×3 cm resin 3-D models depicting each BSFS stool type. The 3-D instrument included clear material inside the mock toilet (10) to represent water in the toilet bowl (12) and tridimensional stool models that “floated” or “sunk” depending on the stool type. The mock toilet bowl (12) was constructed to allow easy introduction and removal of each of the seven tridimensional models of exemplary types of stools from the bowl.

Two focus group sessions were conducted with a group of nurses and pediatric gastroenterologists who approved each step of the construction of the 3-D instrument. The 3-D instrument was considered to fairly represent each stool type and the characteristics of children's stools.

Due to concerns that 2-D pictures may not be appropriate to characterize stools in children with limited abstract capacity all stool types were placed in a mock toilet bowl to simulate the stools in a real world setting. We believed that the use of 3-D models could maximize the child's capability of identifying the different types of stool forms.

Individual 2-D BSFS stool types—The seven stool types of the BSFS were separated from the chart and enlarged to produce seven independent 2-dimensional colored picture cards with white background measuring 5×3 cm corresponding with each stool type.

Methods

Children 6-16 years of age attending the pediatric gastroenterology clinic at Children's Memorial Hospital of Chicago were invited to participate in the study. The age groups in our study closely resembled Piaget cognitive development age groups as defined above. After parental consent was obtained, each child conducted a series of tasks:

1—To explore whether children were able to conceptualize variation in consistency and correctly identify decreasing stool consistency, the children were asked to rank the picture cards of the BSFS from hardest to softest (type 1 to type 7). For this purpose, the children were presented with the seven pictures in random order by a member of the research team.

2—To explore whether a 3-D model was a suitable representation for children, each child was asked to rank the resin stool models from hardest to softest (type 1 to type 7). For this purpose, the children were presented in random order with the seven resin models depicting stool types of the BSFS in the mock toilet bowl water by a member of the research team.

Correlation between rank order of the BSFS and subject's ranking was analyzed for the 2-dimensional colored picture cards and 3-D models.

3—To assess the ability of the BSFS descriptors to characterize the different stool types of the BSFS, the children were asked to match picture cards with the descriptions for each of the seven stool types from the BSFS.

4—To assess the ability of the of the descriptors of the M-BSFS to characterize the different stool type pictures, the children were asked to match the picture cards with the descriptions for each of the seven stool types from the M-BSFS.

5 and 6—To further assess the behavior of the descriptors used in the BSFS and M-BSFS, children were asked to match each of the descriptors with the stool type of the 3-D model.

7—To assess children's ability to correctly conceptualize stool consistency using BSFS pictures and 3-D models, we established whether children's characterization of each stool type could be correctly considered as hard, loose or normal. For this purpose, stool type determination was considered correct if the children identified the picture or 3-D model with a stool type in the range of hard stools (type 1, 2, 3), loose stools (type 5, 6, 7) or normal stools (type 4).

8—To assess the ability of children of different developmental stages to characterize hard (Type 1, 2, 3), normal (Type 4) and loose stools (Type 5, 6, 7), we compared two groups: Group 1—preadolescent children, 6 to 11 years old and Group 2-adolescent children, 12 to 17 years old).

Statistical Analysis

Categorical differences were analyzed by Chi-square and Fisher's exact tests. P-value was calculated using unpaired two-tailed t-test.

### Example 1

### Ordinal Ranking

To explore whether children were able to conceptualize variation in consistency and correctly identify decreasing stool consistency and whether a 3-D model was a suitable representation for children, each child was asked to rank the picture cards of the BSFS and rank the resin stool models from hardest to softest (type 1 to type 7). First, the children were presented with the seven pictures in random order by a member of the research team. Second, the children were presented in random order with the seven resin models depicting stool types of the BSFS in the mock toilet bowl water by a member of the research team.

A total of 50 children, mean age 12.3 years (range 6-16 years), 50% girls participated in the study.

Two percent of children (one 15 year-old-child) ranked the BSFS picture cards correctly from hardest (type 1) to softest (type 7). Two percent of children (one 17 year-old-child) ranked the 3-D models correctly from hardest to softest. Only stool types 6 & 7 on picture cards and the 3-D models were ranked correctly by >70% children.

### Example 2

### Correlation Between the BSFS Picture Cards and BSFS Wording

To assess the ability of the BSFS descriptors to characterize the different stool types of the BSFS, the children were asked to match picture cards with the descriptions for each of the seven stool types from the BSFS.

Eighteen subjects (33%) correlated the stool picture cards with the appropriate BSFS words. There was >70% agreement between the stool pictures and the appropriate words from the BSFS for stool types 2, 3, 4, 6 and 7.

### Example 3

### Correlation Between the Picture Cards (BSFS and M-BSFS) and M-BSFS Wording

To assess the ability of the of the descriptors of the M-BSFS to characterize the different stool type pictures, the children were asked to match the picture cards with the descriptions for each of the seven stool types from the M-BSFS.

Twenty-four subjects (46%) correlated stool picture cards with the appropriate M-BSFS words (p=0.3). Agreement between stool pictures and words from the M-BSFS were >70% for stool types 1, 3, 4, 5, 6 and 7.

Twelve percent of children (4 boys, 2 girls, mean age 14.5 years) correlated the stool picture cards with both, appropriate BSFS and M-BSFS words.

### Example 4

### Correlation Between the BSFS and M-BSFS Wording with the Stool Type of the 3-D Model

To further assess the behavior of the descriptors used in the BSFS and M-BSFS, children were asked to match each of the descriptors with the stool type of the 3-D model.

Correlation between 3-D stool models & words: twenty-four subjects (46%) correlated the 3-D stool models with the appropriate BSFS words. Twenty-six subjects (52%) correlated the 3-D stool models with the appropriate M-BSFS words (p=0.7).

There was >70% agreement between the 3-D stool models and the appropriate words from the BSFS for all stool types except type 5 and with the appropriate words from M-BSFS for all stool types except type 2. Twenty-eight percent of children (8 boys, 6 girls, mean age 15.3 years) correlated 3-D stool models with appropriate BSFS and M-BSFS words.

### Example 5

### Conceptualization of Stool Consistency Using BSFS and 3-D

To assess children's ability to correctly conceptualize stool consistency using BSFS pictures and 3-D models, we established whether children's characterization of each stool type could be correctly considered as hard, loose or normal. For this purpose, stool type determination was considered correct if the children identified the picture or 3-D model with a stool type in the range of hard stools (type 1, 2, 3), loose stools (type 5, 6, 7) or normal stools (type 4).

Differential effect between BSFS pictures and 3-D model: 26% of children 6-11 years of age were able to appropriately classified stools as hard, loose or normal consistency. 45% of children of the same age group appropriately classified the stool types in the 3-D models (p=0.03). 43% of children 12-17 years of age were able to appropriately classified stools as hard, loose or normal consistency using the BSFS and 59% using the 3-D model (p=0.058).

When all correct responses were combined for the BSFS and 3-D model, an average of 35% of correct answers were found when the BSFS was used vs. 52% of correct answers with the 3-D model (p=0.004).

### Example 6

### Conceptualization of Stool Consistency by Age Groups

To assess the ability of children of different developmental stages to characterize hard (Type 1, 2, 3), normal (Type 4) and loose stools (Type 5, 6, 7), we compared two groups: Group 1—preadolescent children, 6 to 11 years old and Group 2—adolescent children, 12 to 17 years old).

Correct characterization of stools in all groups was 26% in children of the younger age group (6-11 years) using the BSFS and 43% in the older age group (12-17 years) (p=0.04); and 45% in children of the younger age group (6-11 years) using the 3-D model and 59% in the older age group (12-17 years) (p=0.1). This suggests a better understanding of the BSFS in older children than younger children, while the understanding of the 3-D model is similar in children of both age groups.

Group 1—preadolescent children, 6 to 11 years old: 23 children (46% of sample). Thirty-nine percent of children classified correctly the BSFS picture cards into the hard category, 21% into the loose category and 17% into the normal stools category.

Similar task using the 3-D model, 69% of children classified correctly the models into the hard category, 39% into the loose category and 26% into the normal stools category. See Table 1.

Group 2—adolescent children, 12 to 17 years old: 27 children (54% of sample). Fifty five percent of children classified correctly the BSFS picture cards into the hard category, 44% into the loose category and 29% into the normal stools category.

Similar task using the 3-D model, 77% of children classified correctly the stool models into the hard category, 63% into the loose category and 37% into the normal stools category. See Table 1.

TABLE 1
Characterization of stools: hard (Type 1, 2, 3), loose (Type 5, 6, 7) and
normal (Type 4)

| | Hard | | | | Loose | | | | Normal | | | |
|---|---|---|---|---|---|---|---|---|---|---|---|---|
| | Group 1 | Group 2 | Overall | | Group 1 | Group 2 | Overall | | Group 1 | Group 2 | Overall | |
| | n = 23 | n = 27 | correct | | n = 23 | n = 27 | correct | | n = 23 | n = 27 | correct | |
| | (46%) | (54%) | response | | (46%) | (54%) | response | | (46%) | (54%) | response | |
| BSFS | 9 (39%) | 15 (55%) | 48% | P = 0.01 | 5 (22%) | 12 (44%) | 34% | P = 0.1 | 4 (17%) | 8 (29%) | 24% | P = 0.5 |
| 3-D | 16 (69%) | 21 (77%) | 74% | | 9 (39%) | 17 (63%) | 52% | | 6 (26%) | 10 (37%) | 32% | |

G1: 26% BSFS 3-D 45% p = 0.03
G2: 43% BSFS 3-D 59% p = 0.06

It was found that the percentage of children at the formal operational state that could characterize correctly the various stool types was superior to the percentage of children that were able to characterize correctly the various stool types at the concrete operational state.

Percentage differences among ages were superior for both the BSFS and 3-D model but only statistically significant for the BSFS. It is possible that this variation among diagnostic instruments may result from the size of our sample, as those differences would have been significant if the sample was larger. A sample size calculation has shown that differences between age groups would have also been significant for the BSFS with a sample of 199 children using a power of 0.8 with a level of significance of 0.05.

In conclusion, it was shown that available and widely used stool assessment instruments are not friendly to be used in children. The use of 3-D models may provide significant advantages over the use of the “standard” stool assessment instruments and methods.

While there has been shown and described a preferred embodiment of the invention, it is to be understood that various other adaptations and modifications may be made by those skilled in the art without departing from the spirit and scope of the invention.

1. A tridimensional stool assessment instrument for evaluating stool type of a subject comprising:
a toilet; and
at least one tridimensional model of an exemplary stool type sized for placement in the toilet.

2. The tridimensional stool assessment instrument of claim 1, wherein the subject is an adult subject.

3. The tridimensional stool assessment instrument of claim 1, wherein the subject is a pediatric subject.

4. The tridimensional stool assessment instrument of claim 1, wherein the toilet is a mock toilet.

5. The tridimensional stool assessment instrument of claim 4, wherein the mock toilet resembles in size a working toilet.

6. The tridimensional stool assessment instrument of claim 4, wherein the mock toilet is reduced in size as compared to a working toilet.

7. The tridimensional stool assessment instrument of claim 4, wherein the mock toilet is approximately 25 cm in height.

8. The tridimensional stool assessment instrument of claim 4, wherein the mock toilet is made from a resin material.

9. The tridimensional stool assessment instrument of claim 1, wherein the subject has, or is at risk of acquiring a gastrointestinal disease.

10. The tridimensional stool assessment instrument of claim 9, wherein the gastrointestinal disease is selected from the group consisting of gastrointestinal motility disorder, chronic intestinal pseudo-obstruction, colonic pseudo-obstruction, duodenogastric reflux, dyspepsia, functional dyspepsia, nonulcer dyspepsia, functional gastrointestinal disorder, functional heartburn, gastroesophageal reflux disease, gastroparesis, irritable bowel syndrome, post-operative ileus, and constipation.

11. The tridimensional stool assessment instrument of claim 1, wherein the subject has, or is at risk of acquiring, flu, biliary atresia, cystic fibrosis, intussusception, polyps or cancer.

12. The tridimensional stool assessment instrument of claim 1, comprising at least five tridimensional models of exemplary stool types.

13. The tridimensional stool assessment instrument of claim 1, comprising at least seven tridimensional models of exemplary stool types.

14. The tridimensional stool assessment instrument of claim 1, comprising a plurality of tridimensional models of exemplary stool types.

15. The tridimensional stool assessment instrument of claim 1, the instrument comprising at least seven tridimensional models of the exemplary stool types, the stool types corresponding to the seven types of stools depicted by the Bristol Stool Scale Form.

16. The tridimensional stool assessment instrument of claim 1, wherein the tridimensional model of stool is made from a resin material.

17. The tridimensional stool assessment instrument of claim 1, wherein the tridimensional stool model has an appearance of floating or sinking in the mock toilet depending on the stool type.

18. The tridimensional stool assessment instrument of claim 3, further comprising a tridimensional model of blood, a tridimensional model of mucus, and a tridimensional model of pus sized for placement in the mock toilet on top of the at least one tridimensional model of an exemplary stool type.

19. The tridimensional stool assessment instrument of claim 1, further comprising a tridimensional clear model sized for placement in the mock toilet on top of the at least one tridimensional model of an exemplary stool type.

20. The tridimensional stool assessment instrument of claim 1, wherein the instrument is for educational use.

21. A method of evaluating a subject having, or having a propensity to develop a gastrointestinal disease comprising:
i) providing a tridimensional stool assessment instrument to the patient, the instrument comprising
a toilet; and
a plurality of tridimensional models of an exemplary stool types sized for placement in the toilet,
ii) placing individual tridimensional models of the exemplary stool types in the toilet;
iii) instructing the subject to identify the tridimensional stool model that best resembles the stool type of the subject.

22. The method of claim 21, wherein the gastrointestinal disorder is selected from the group consisting of gastrointestinal motility disorder, chronic intestinal pseudo-obstruction, colonic pseudo-obstruction, duodenogastric reflux, dyspepsia, functional dyspepsia, nonulcer dyspepsia, functional gastrointestinal disorder, functional heartburn, gastroesophageal reflux disease, gastroparesis, irritable bowel syndrome, post-operative ileus, and constipation.

23. The method of claim 21, wherein the subject is a pediatric subject.

24. A method of diagnosing a subject as having, or having a propensity to develop, an inflammatory bowel disease or constipation, the method comprising
i) providing a tridimensional stool assessment instrument to the subject, the instrument comprising
a toilet; and
a plurality of the tridimensional models of an exemplary stool types sized for placement in the toilet,
ii) placing individual tridimensional models of the exemplary stool types in the toilet; and
iii) instructing the subject to identify the tridimensional stool model that best resembles the stool type of the subject.

25. A kit comprising:
i) a mock toilet;
ii) at least one tridimensional model of an exemplary stool type sized for placement in the mock toilet; and optionally
iii) a tridimensional model of blood;
iv) a tridimensional model of mucus;
v) a tridimensional model of pus,
wherein the tridimensional models of blood, mucus, and pus are sized for placement in the mock toilet on top of the at least one tridimensional model of an exemplary stool type.
